(19) United States
(12) Patent Application Publication
(10) Pub. No.: US 2005/0064748 A1
(43) Pub. Date: Mar. 24, 2005

(54) SIM card connector

(76) Inventors: Qisheng Zheng, Kunsan (CN); Bo Chen, Kunsan (CN); Shao Ping Du, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/946,448

(22) Filed: Sep. 20, 2004

(30) Foreign Application Priority Data
Sep. 19, 2003 (TW) 92216890

(51) Int. Cl. H01R 13/44

(52) U.S. Cl. 439/150

(57) ABSTRACT

A SIM card connector (100) comprises a base (1), a cover (2) and a pivot (3) for pivotally connecting the cover with the base. The base includes an insulative housing (11) and a plurality of resilient conductive terminals received in the housing. The cover includes a top cover (21), a rear cover (23) on a rear edge of the top cover, opposite side plates on opposite sides of the top cover and a receptacle (20) for receiving a card (4) being defined by the top cover, the rear cover and the side plates. An elongate rib (241) is downwardly formed on the top cover and adjacent to the receptacle. The rib and the terminals cooperate together to secure reading of the inserted card and prevent a forward movement of the inserted card.

### BACKGROUND OF THE INVENTION

1. Field of the Invention

The present invention generally relates to an electrical connector, and more particularly, to a card connector capable of reliably holding an inserted card.

2. Description of the Related Art

A Subscriber Identity Module (SIM) card connectors are popularly used in mobile communications for connecting electrical cards to printed circuit boards. A SIM card is a module which identifies the identity of a subscriber. U.S. Pat. No. 6,095,868 discloses a card connector including a base, a plurality of terminals and a removable cover. A protrusion extends upwardly from front portion of the base and has a card stop surface preventing a forward movement of an inserted card. An inwardly directed cantilevered beam extends downwardly from a top cover for providing frictional force on the inserted card and for strengthening the connection between the inserted card and the card connector when the card is fully inserted into the card connector.

To guarantee the connection between the card and the terminals of the connector, the protrusion and the cantilevered beam are provided. However, the protrusion formed at the front portion of the base bothers the insertion of the card. Furthermore, the cantilevered beam of a current card connector is too tiny to provide enough downwardly force to steady the connection between the card and the terminals.

### SUMMARY OF THE INVENTION

The present invention is directed to a SIM card connector that alleviates some of the problems associated with the prior art. Accordingly, the primary object of the present invention is to provide a new and improved electrical card connector for a secure and precise contact with an inserted card and can be manufactured at low lost.

A SIM card connector in accordance with the present invention comprises a base, a cover and a pivot for pivotally connecting the cover with the base. The base includes an insulative housing and a plurality of resilient conductive terminals received in the housing. The resilient terminal includes a top contact terminal for elastically and electrically connecting the inserted card, a middle spring and a bottom fixing terminal for being fixed on the printed circuit board. The spring is positioned between the contact terminal and the fixing terminal so that the contact terminal can be resiliently moved upwardly and downwardly. The cover includes a top cover, a rear cover on a rear edge of the top cover and opposite side plates on opposite sides of the top cover and a receptacle for receiving a card being defined by the top cover, the rear cover and the side plates. A rib is downwardly formed on the top cover and adjacent to the receptacle for preventing a front movement of the inserted card.

Advantages of this invention include that it provides a SIM card connector having the elongate rib formed on the top cover. The rib and the resilient terminals of the base cooperate together to secure the reading of the inserted card and safeguard the inserted card from movement. The pivotal cover that receives and holds the card therein as the card and the cover are assembled to the base. It is preferred that no separate components are necessary, for instance, a separate cover. Furthermore, the insertion and extraction, respectively, of the card is convenient to users and it is possible without any tools.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a SIM card connector according to the present invention, but with a card received therein;

FIG. 2 is another perspective view of the SIM card connector;

FIG. 3 is an exploded view of FIG. 1;

FIG. 4 is an exploded view of FIG. 2;

FIG. 5 is a perspective view of a base of the SIM card connector according to the present invention;

FIG. 6 is an upside-down view of FIG. 5;

FIG. 7 is an explode view of FIG. 5; and

FIG. 8 is a cross-sectional view taken along line 8-8 of FIG. 5.

### DETAILED DESCRIPTION OF THE PREFERRED EMBODIMENT

Reference will now be made in detail to the preferred embodiment of the present invention.

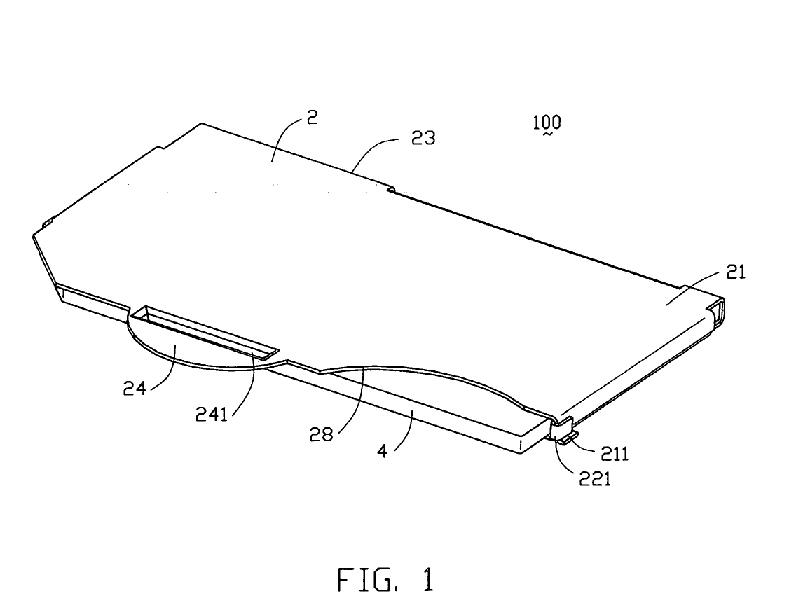

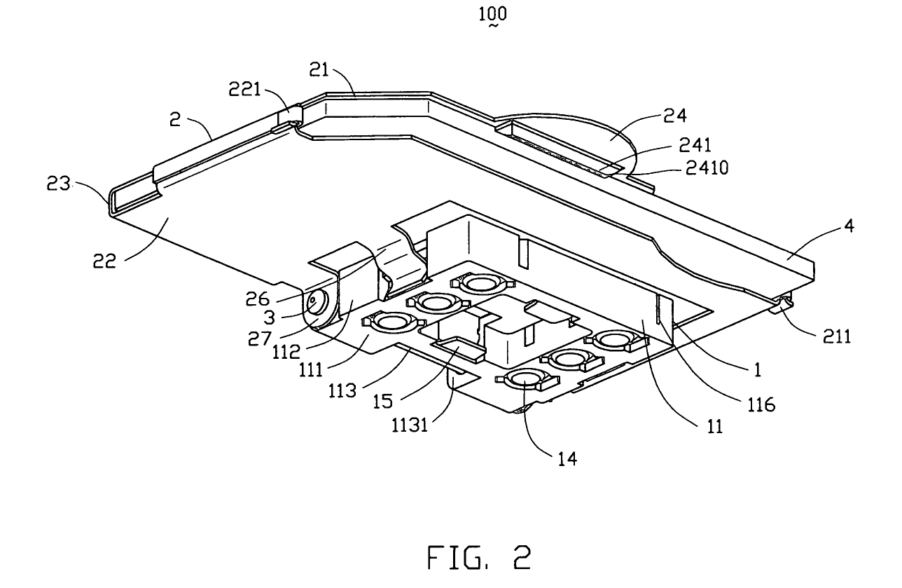

Referring to FIGS. 1-4, a SIM connector 100 in accordance with the present invention comprises a base 1, a cover 2 and a pivot 3 for pivotally connecting the cover 2 with the base 1.

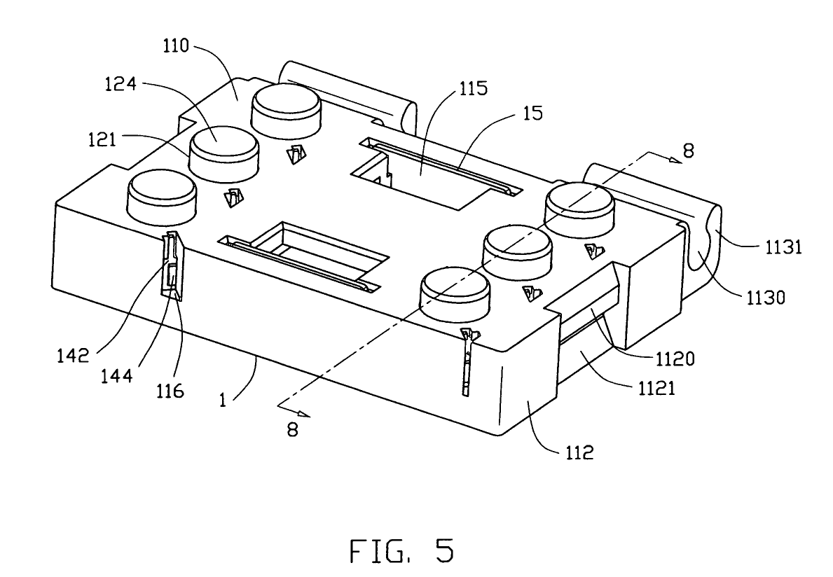

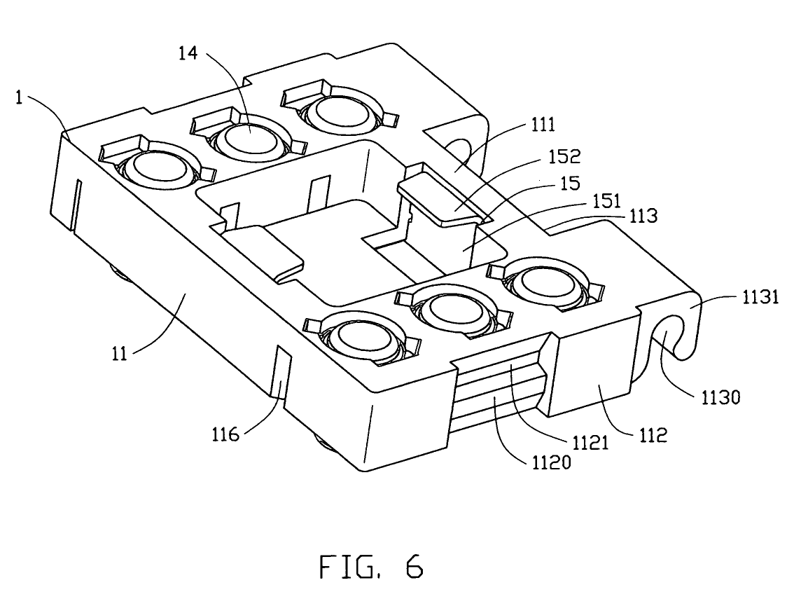

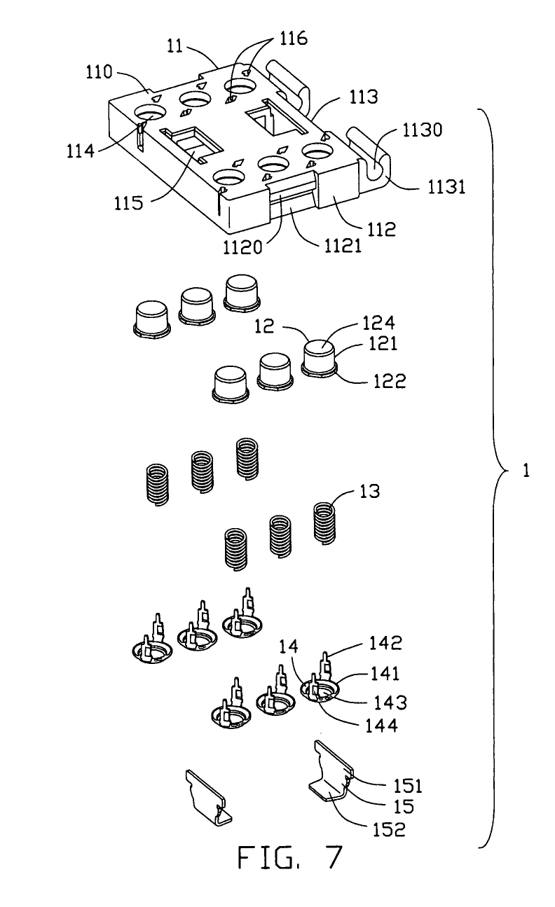

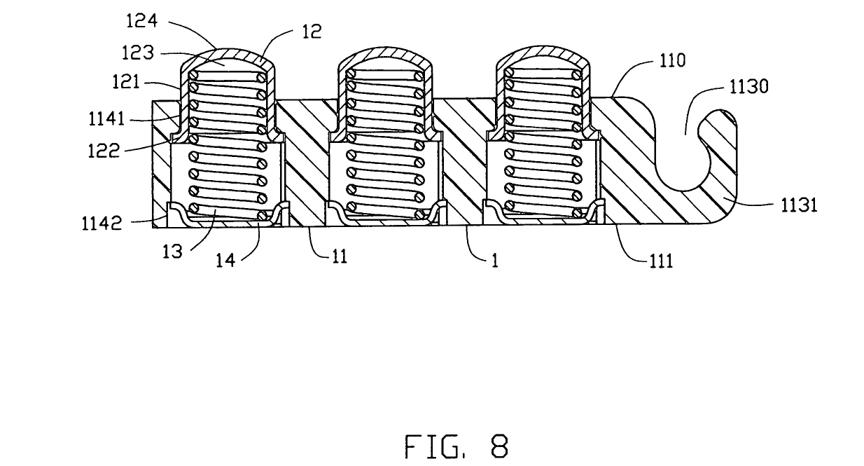

Referring to FIGS. 5-8, the base 1 includes a substantially rectangular insulative housing 11, a plurality of resilient conductive terminals received in the housing 11 and a pair of engaging sheets 15. The housing 11 includes an upper surface 110, a lower surface 111, opposite side walls 112 and a rear wall 113. The housing 11 defines a plurality of through holes 114 through the upper and lower surfaces 110, 111 adjacent to the opposite side walls and defines a pair of engaging slots 115 at middle thereof. The housing 11 includes a top step 1141 inwardly and radially projecting into a top portion of each through hole 114. The housing 11 defines a recess communicating with a bottom portion of each through hole 114. The recess has the same axis as each through hole 114 and has a diameter larger than that of each through hole 114, thereby forming a bottom step 1143 in the bottom portion of the each through hole 114. The housing 11 has a plurality of pairs of parallel fixing slots 116 through the upper and lower surfaces 110, 111 and each pair of fixing slots 116 are position at opposite sides of each through hole 114. Each side wall 112 forms an outwardly projecting protrusion 1120 and defines a concaved resistant slot 1121 beneath the protrusion 1120. A pair of hook portions 1131 extend rearwardly and upwardly from opposite side portions of the rear wall 113 and each hook portion 1131 defines an upwardly exposed cylindric groove 1130.

The conductive terminals are received in the through holes 114 of the housing 11 and each comprises a contact terminal 12, a spring 13 and a fixing terminal 14. Each contact terminal 12 includes a sleeve body section 121 and a convex contact section 124 covering at a top end of the body section 121 for contacting with circuit traces of an inserted card 4. The body section 121 and the convex contact section 124 define a downwardly exposed recess 123. A mounting flange 122 extends perpendicularly and outwardly from a lower periphery of the body section 121 and cooperates with the top step 1141 of the housing 11.

The fixing terminal 14 includes a base portion 141 and a pair of symmetrical fixing arms 142 extending upwardly from the base portion 141. The base portion 141 has a substantially cap-shaped configuration and defines an upwardly exposed hollow space 143 for abutting against a lower end of the spring 13. The base portion 141 has a bottom solder nod (not labeled) for soldering to a printed circuit board (PCB, not shown). Each fixing arm 142 has an outwardly projecting tuber 144 formed thereon for cooperating with the fixing slots 116 of the housing 11.

The spring 13 is received in the through hole 114 of the housing 11. The lower end of the spring 13 abuts against the hollow space 143 and the upper end of the spring 13 extends into the recess 123 abutting against an inner surface of the convex contact section 124.

Each engaging sheet 15 includes a vertical engaging portion 151 latching in the engaging slot 115 of the housing 11 and a solder portion 152 perpendicularly and inwardly extending from a lower end of the engaging portion 151 for soldering to the PCB.

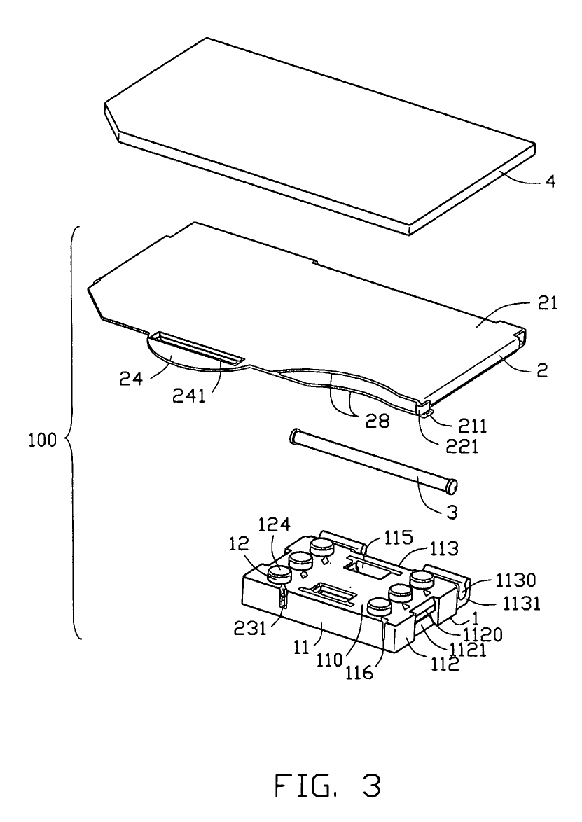

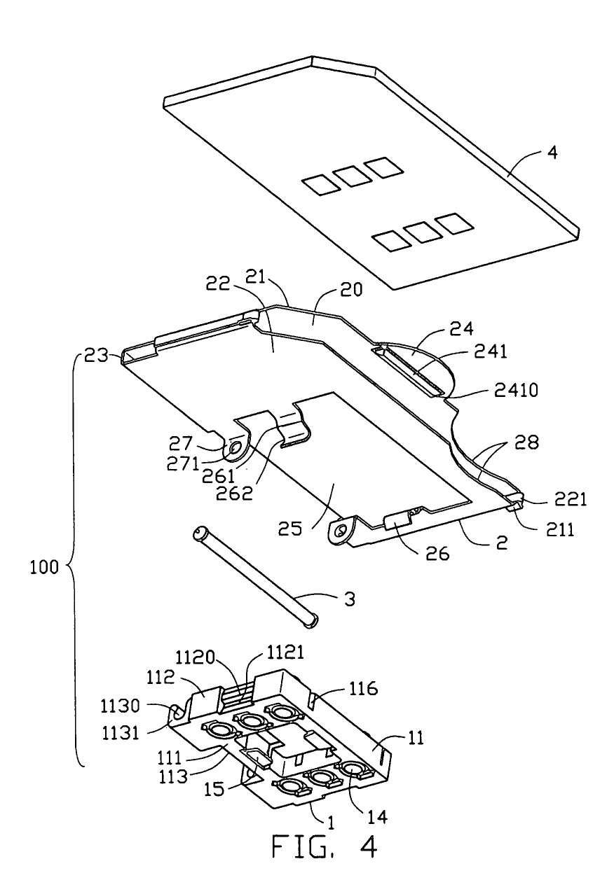

Referring to FIGS. 3 and 4, the cover 2 includes a top cover 21, a bottom cover 22 and a rear cover 23 extending between rear edges of the top cover 21 and the bottom cover 22. The top cover 21 comprises a pair of downwardly extending lateral plates. A pair of locking bards 211 extend outwardly and perpendularly from front portions of bottom edges of corresponding lateral plates. The bottom cover 22 comprises a pair of upwardly extending side plates to abut against inner surfaces of the downwardly extending lateral plates of the lock bards 211. A pair of hooks 221 extend from front edges of corresponding side plates of the bottom cover 22 for abutting against outer surfaces of the corresponding lateral plates of the top cover 21. The locking bards 211 cooperate with the hooks 221 so as to mount the top cover 21 and the bottom cover 22 together, thereby defining a receptacle 20 for receiving the card 4 between the top cover 21 and the bottom cover 22. The height of the receptacle 20 is greater than the thickness of the card 4. A front nose portion 24 extends forwardly from a front edge of the top cover 21. An elongate rib 241 is downwardly formed on the front nose portion 24 and is parallel to the rear cover 23. The rib 241 is positioned in front of the receptacle 20 and has a leading surface 2410 for leading the card 4 into/out the receptacle 20. The bottom cover 22 has a cutout 25 through a rear portion thereof and a pair of resilient latch arms 26 extending downwardly and inwardly to each other from the opposite sides of the cutout 25. The latch arm 26 includes a middle concave portion 261 projecting downwardly and an inwardly projecting snapping portion 262 on a distal free end thereof for securely grasping the base 1 therebetween. The cover 2 has a pair of blades 27 extending perpendicularly and downwardly from the bottom cover 2. Each blade 27 is adjacent to a corresponding latch arm 26 and has a pinhole 271 for cooperating with an end of the pivot 3. The cover 2 defines a pair of concave peripheries 28 on top cover 21 and bottom cover 22 for facilitating to extract the inserted card 4.

The pivot 3 has a substantially cylinder-shaped configuration. The pivot 3 is assembled in the pinholes 271 and engages with the cylindric grooves 1130 of the hook portions 1131 of the housing 1, whereby the cover 2 is pivotally mounted on the base 1 and can pivotally move toward and away of the base 1.

In assembly, the contact terminals 12 are installed into the through holes 114 of the housing 11 from the lower surface 111 of the housing 11. The body section 121 and the convex contact section 124 of each contact terminal 12 projects beyond the upper surface 110 of the housing 11. The mounting flanges 122 of the contact terminals 12 engage with the top steps 1141 of corresponding through holes 114. The springs 13 are received in the through holes 114 of the housing 11 and the upper end of each spring 13 extends into the recess 123 of the contact terminal 12. The fixing terminals 14 are fixed to the bottom steps 1142 of the though holes 114 from the lower surface 111 of the housing 11. The fixing arms 142 of the fixing terminals 14 are inserted into the fixing slots 116 of the housing 11 with the tubers 144 abutting against the inner surfaces of the fixing slots 116, thereby fixing the fixing terminals 14 to the housing 11. Then in assembly of the cover 2 to the base 1, the pivot 3 engages with the cylindric grooves 1130 and seats into the pinholes 271 of the blades 27 of the bottom cover 22. The snapping portions 262 of the latch arms 26 snap corresponding resistant slots 1121 and the concave portions 261 engage with the protrusions 1120 of the housing 11, thereby securely retaining the base 1 therebetween.

In using, the top cover 21 is pivotally lifted away the base 1 and the card 4 is inserted into the receptacle 20 of the cover 2. Then, the top cover 21 is downwardly pressed to the base 1 and the latch arms 26 retaining the base 1 therebetween. The card 4 exerts a downwardly depressing force on the contact terminals 12. At the same time, the card 4 gets an upward counterforce from the depressed contact terminal 12 and the spring 13 and is upwardly pushed to abut against the top cover 21. The card 4 is retained by the top cover 21 and depresses the contact terminal 12 and the spring 13 so that cannot move in top-and-bottom directions. Meanwhile a front edge of the card 4 is retained by the rib 231 of the top cover 21 and a rear cover 23 so that cannot move in front-and-rear directions, thereby securely retaining the card 4 in the receptacle 20. When the cover 2 pivots away the base 1, the latch arms 26 disengage from the base 1. The card 4 separates with the depressed contact terminals 12 and is free from the upwardly counterforce from the contact terminals 12 and the springs 13. The card 4 falls on inner surface of the bottom cover 22 and is simultaneously relaxed to the rib 231 of the top cover 21. In such a free state, the card 4 can be easily extracted from the receptacle 20 along the inner surface of the bottom cover 22 easily.

It is to be understood, however, that even though numerous, characteristics and advantages of the present invention have been set fourth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

1. A SIM card connector adapted for being mounted on a printed circuit board for an inserted card, comprising:
a base including an insulative housing and a plurality of resilient conductive terminals received in the housing;
a cover including a top cover, a bottom cover, a rear cover on a rear edge of the top cover and opposite side plates on opposite sides of the top cover, a receptacle for receiving a card being defined by the top cover, the bottom cover, the rear cover and the side plates, a rib downwardly formed on the top cover and adjacent to the receptacle for preventing a forward movement of the inserted card; and
a pivot for pivotally connecting the base with the cover.

2. The SIM card connector according to claim 1, wherein the rib has a leading surface for leading the card into/out the receptacle.

3. The SIM card connector according to claim 1, wherein the rib is elongate and is substantially parallel to the rear cover.

4. The SIM card connector according to claim 1, wherein the cover has means for mounting the pivot.

5. The SIM card connector according to claim 1, wherein the resilient terminal includes a top contact terminal for elastically and electrically connecting the inserted card, a middle spring and a bottom fixing terminal for being fixed on the printed circuit board, the spring positioned between the contact terminal and the fixing terminal so that the contact terminal can be resiliently moved upwardly and downwardly.

6. The SIM card connector according to claim 5, wherein the cover has a cutout facing to an upper surface of the base, the contact terminal projecting upwardly into the receptacle through the cutout.

7. The SIM card connector according to claim 6, wherein the cover has at least one latch arm locking with the base in a closed position.

8. A SIM card connector adapted for being mounted on a printed circuit board for an inserted card, comprising:
a base including an insulative housing and a plurality of resilient conductive terminals received therein, each terminal including a top contact terminal normally upwardly projecting beyond the housing, a middle spring and a bottom fixing terminal for being fixed on the printed circuit board, the spring positioned between the contact terminal and the fixing terminal so that the contact terminal can be resiliently moved upwardly and downwardly;
a cover including a top cover and a bottom cover defining a receptacle for receiving a card, a rib downwardly formed on the top cover and adjacent to the receptacle for preventing a forwardly movement of the inserted card; and
a pivot for pivotally connecting the base with the cover.

10. The SIM card connector according to claim 9, wherein the rib has a leading surface for leading the card into/out the receptacle.

11. The SIM card connector according to claim 10, wherein the rib is elongate and is substantially parallel to the rear cover.

12. The SIM card connector according to claim 9, wherein the cover has means for mounting the pivot.

13. The SIM card connector according to claim 12, wherein the cover has a cutout facing to an upper surface of the base, the contact terminal projecting upwardly into the receptacle throng the cutout into the receptacle.

14. The SIM card connector according to claim 13, wherein the cover has at least one latch arm locking with the base in a closed position.

15. A SIM card connector adapted for being mounted on a printed circuit board, comprising:
a base including an insulative housing and a plurality of resilient conductive terminals received in the housing;
a cover pivotally mounted to a rear end of the base and defining a receiving cavity;
a SIM card inserted into the receiving cavity; wherein
said base is much smaller than the cover in both lengthwise and lateral directions which are perpendicular to each other, and is located within a periphery defined by said cover in both said lengthwise and said lateral directions.

16. The SIM card connector as claimed in claim 15, wherein retention means is formed on a periphery of said base to retain said base and said cover in a parallel relation.

17. The SIM card connector as claimed in claim 15, wherein said receiving cavity is essentially defined by four fully surrounding walls.

18. The SIM card connector as claimed in claim 15, wherein retention means is formed on the cover to prevent said inserted SIM card from backward moving.
